(19) United States
(12) Patent Application Publication
(10) Pub. No.: US 2004/0093282 A1
(43) Pub. Date: May 13, 2004

(54) Method and system for providing previous selection information

(75) Inventors: Anna L. Buczak, Moorestown, NJ (US); John Zimmerman, Pittsburgh, PA (US); Kaushal Kurapati, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/291,037

(22) Filed: Nov. 8, 2002

(51) Int. Cl. G06F 17/60

(52) U.S. Cl. 705/27

(57) ABSTRACT

A method for providing previous selection information to a user is provided that includes generating a list of possible selections based on a selection request received from the user. A selection history table is accessed to identify previous selections by the user. A determination is made regarding whether a selection in the list of possible selections matches a previous selection. The user is informed when a determination is made that a selection in the list of possible selections matches a previous selection.

### TECHNICAL FIELD OF THE INVENTION

The present invention relates generally to information and commerce distribution and, more particularly, to a method and system for providing previous selection information.

### BACKGROUND OF THE INVENTION

Many information and commerce providers are available one-line for providing downloadable content or goods and services for purchase by users. These on-line content and commerce providers typically keep track of the content that a user has downloaded or the items that a user has purchased from the provider in the past. However, this information is not available to the user. As a result, a user may, for example, download the same song or purchase the same book or compact disc multiple times without realizing that he or she has previously downloaded or purchased the item.

### SUMMARY OF THE INVENTION

In accordance with the present invention, a method and system for providing previous selection information are provided that substantially eliminate or reduce disadvantages and problems associated with conventional systems and methods. In particular, when receiving a list of possible selections from a provider, a user is informed of previously made selections in order to prevent unintended duplicate selections.

According to one embodiment of the present invention, a method for providing previous selection information is provided. The method includes generating a list of possible selections based on a selection request received from the user. A selection history table is accessed to identify previous selections by the user. A determination is made regarding whether a selection in the list of possible selections matches a previous selection. The user is informed when a determination is made that a selection in the list of possible selections matches a previous selection.

According to another embodiment of the present invention, a system for providing previous selection information in a network is provided that includes a selection history table and a previous selection indicator. The selection history table is operable to store information relating to previous selections by the user. The previous selection indicator is operable to access the selection history table, to identify a previous selection by the user and to inform the user of the previous selection.

Technical advantages of one or more embodiments of the present invention include providing a method for providing previous selection information to a user. In a particular embodiment, when a user requests a list of selections from a provider, the provider informs the user of any previously made selections by the user. As a result, the user may avoid making an unintended duplicate selection from the list of possible selections.

Other technical advantages will be readily apparent to one skilled in the art from the following figures, description, and claims.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating a communication system operable to provide previous selection information to a user in accordance with one embodiment of the present invention;

FIG. 2A illustrates the selection history table of FIG. 1 in accordance with one embodiment of the present invention;

FIG. 2B illustrates the selection history table of FIG. 1 in accordance with another embodiment of the present invention; and

FIGS. 3A-B are flow diagrams illustrating a method for providing previous selection information to a user in the communication system of FIG. 1 in accordance with one embodiment of the present invention.

### DETAILED DESCRIPTION OF THE INVENTION

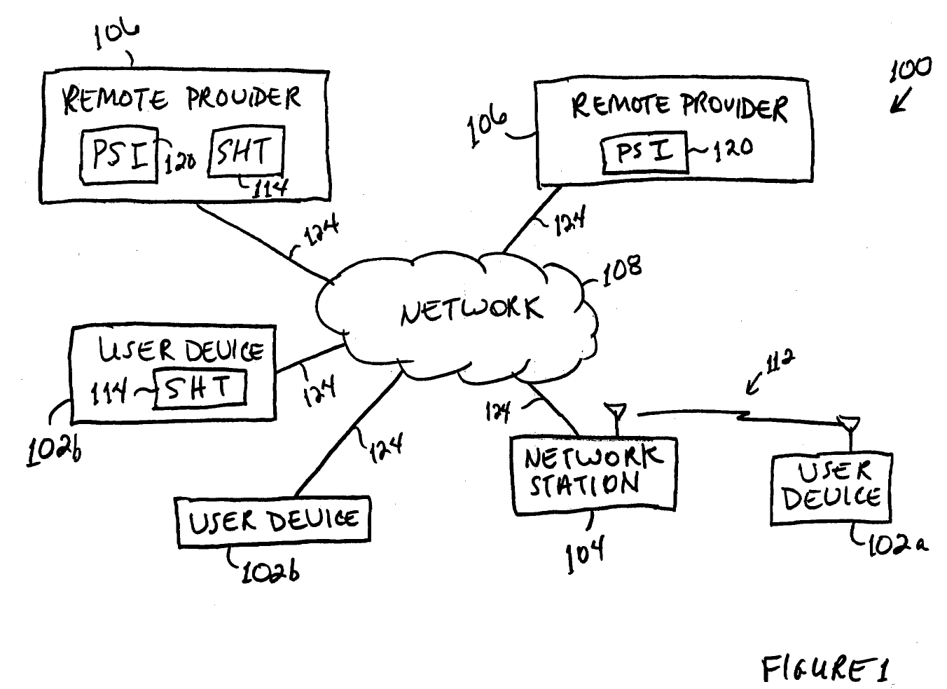

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged communication system.

FIG. 1 is a block diagram illustrating a communication system 100 that is operable to provide previous selection information to a user in accordance with one embodiment of the present invention. The communication system 100 may comprise a plurality of user devices 102, a plurality of network stations 104 for providing communication for wireless user devices 102a located in specified geographical areas, at least one remote provider 106 for providing information, goods and/or services to users, and a network 108 for providing communication between non-wireless user devices 102b, network stations 104, and a plurality of servers, including the remote provider 106. It will be understood that the system 100 may comprise any other suitable components of a communication system, such as other suitable servers coupled to the network 108, without departing from the scope of the present invention.

Each user device 102 may comprise a personal computer, a laptop computer, a cellular or other mobile telephone, or other suitable device capable of communicating with a network station 104 and/or the network 108. As used herein, “each” means every one of at least a subset of the identified items. Each user device 102 may comprise a wireless user device 102a or a nonwireless user device 102b or may comprise a device operable to communicate as both a wireless and a non-wireless device.

Each wireless user device 102a is operable to communicate with a network station 104 over a wireless interface 112. Thus, the wireless interface 112 is operable to transfer messages between a wireless user device 102a and a network station 104. The wireless interface 112 may comprise communication channels defined upon radio links, such as an Enhanced Data for GSM (Global System for Mobile communications) Evolution interface, a Wideband Code Division Multiple Access interface, or any other suitable interface.

User devices 102 and/or the remote provider 106 may comprise a selection history table (SHT) 114 that is operable to store download and/or purchase history information for a particular user. For example, some remote providers 106 may comprise selection history tables 114 for users, while other remote providers 106 may generate the selection history table 114 to be stored in user devices 102. In addition, the selection history table 114 may be stored in any other suitable location that is accessible by the remote provider 106 through the network 108.

For an embodiment in which the selection history table 114 is stored in a location other than the user device 102, the selection history table 114 may comprise one or more data stores. For example, the selection history table 114 may comprise a single data store that is operable to store data regarding previous selections for a plurality of users, a data store for each user that is operable to store data regarding previous selections for a single user, or any combination thereof.

Each network station 104 is operable to provide wireless user devices 102a with access to voice and/or data networks by providing voice and/or data messages received from the wireless user devices 102a to the network 108 and messages received from the network 108 to the wireless user devices 102a. According to one embodiment, the network stations 104 comprise base stations for a public land mobile network and the wireless user devices 102a comprise mobile telephones.

The remote providers 106 are coupled to the network 108 and are operable to provide information, goods and/or services to users of the user devices 102. For example, the remote providers 106 may comprise content providers that make information available to users for downloading onto the user devices 102 and e-commerce providers that offer goods and/or services to users for purchase through the user devices 102.

The remote providers 106 may each comprise a previous selection indicator (PSI) 120 that is operable to access the selection history table 114, to identify a previous selection by the user in the selection history table 114, and to inform the user of the previous selection. The previous selection indicator 120 is operable to inform the user of the previous selection by re-prioritizing a list of possible selections with the previous selection at the bottom of the list, by positively identifying the previous selection, such as by downlighting or highlighting the previous selection or marking the previous selection with a specified symbol, by removing the previous selection from a list of possible selections to be chosen by the user, or by any other suitable means. The manner in which the previous selection indicator 120 informs the user may be established in the remote provider 106, based on a choice by the user, or in any other suitable way.

Also, the previous selection indicator 120 may be operable to combine selection history tables 114 for multiple users such that if any of the multiple users has previously downloaded or purchased an item, each of those users is informed of the previous selection when being given selection options.

The previous selection indicator 120 may also be operable to store download and/or purchase history information in the selection history table 114 when the user makes a selection. Alternatively, any other suitable component of the remote provider 106 may be operable to store download and/or purchase history information in the selection history table 114 when the user makes a selection.

At least a portion of the remote provider 106, such as the previous selection indicator 120 and other suitable components, may comprise logic encoded in media. The logic comprises functional instructions for carrying out program tasks. The media comprises computer disks or other computer-readable media, application-specific integrated circuits, field-programmable gate arrays, digital signal processors, other suitable specific or general purpose processors, transmission media or other suitable media in which logic may be encoded and utilized.

In one embodiment, the network 108 comprises a packet data network, such as the Internet, or other suitable network. However, the network 108 may also comprise any interconnection found on any computer network such as a local area network (LAN), a wide area network (WAN), or any other communications and data exchange systems created by connecting two or more computers.

Each non-wireless user device 102b, each network station 104, and each remote provider 106 is operable to communicate with the network 108 over communication lines 124, which may be any type of communication link capable of supporting data transfer. In one embodiment, the communication lines 124 may comprise, alone or in combination, Integrated Services Digital Network (ISDN), Asymmetric Digital Subscriber Line (ADSL), T1 or T3 communication lines, hardwire lines, or telephone links. It will be understood that the communication lines 124 may comprise other suitable types of data communication links. The communication lines 124 may also connect to a plurality of intermediate servers between the network 108 and the non-wireless user devices 102b, the network stations 104, and the remote provider 106.

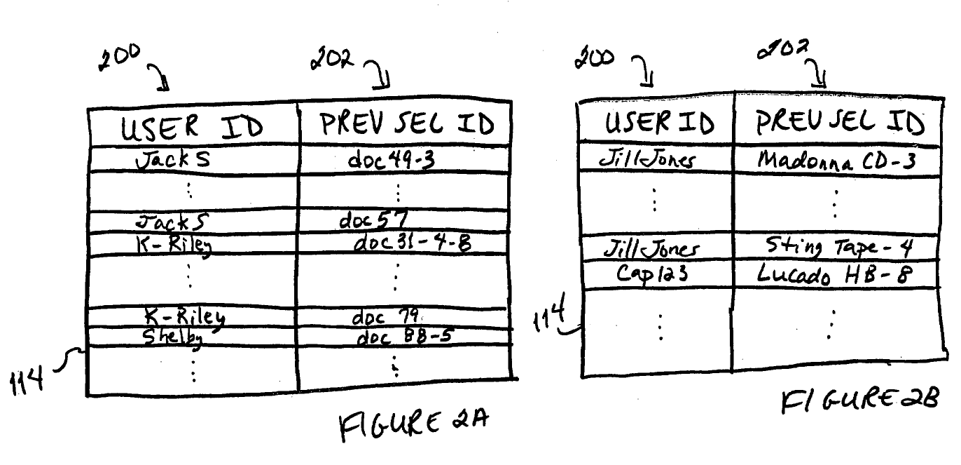

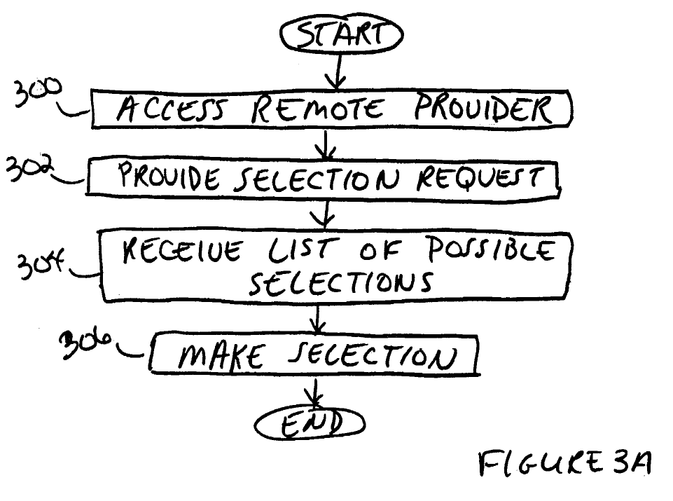

FIGS. 2A-B illustrate the selection history table 114 in accordance with two embodiments of the present invention. Although the selection history table 114 is illustrated and described as a table, it will be understood that the selection history table 114 may comprise any suitable data store operable to store the relevant information without departing from the scope of the present invention.

The selection history table 114 illustrated in FIG. 2A may correspond to a remote provider 106 that comprises a content provider, and the selection history table 114 illustrated in FIG. 2B may correspond to a remote provider 106 that comprises an e-commerce provider.

Both selection history tables 114 illustrated in FIGS. 2A-B comprise user identifiers 200 and previous selection identifiers 202. However, it will be understood that, for the embodiment in which the selection history table 114 is stored in the user device 102, the selection history table 114 may comprise only the previous selection identifiers 202.

Each user identifier 200 may comprise text or other suitable data that is operable to identify a particular user. In addition, each user identifier 200 may comprise a password (not illustrated in FIGS. 2A-B) to verify the identity of the user. Each previous selection identifier 202 may comprise text or other suitable data that is operable to identify a previous selection made by the user identified by the corresponding user identifier 200.

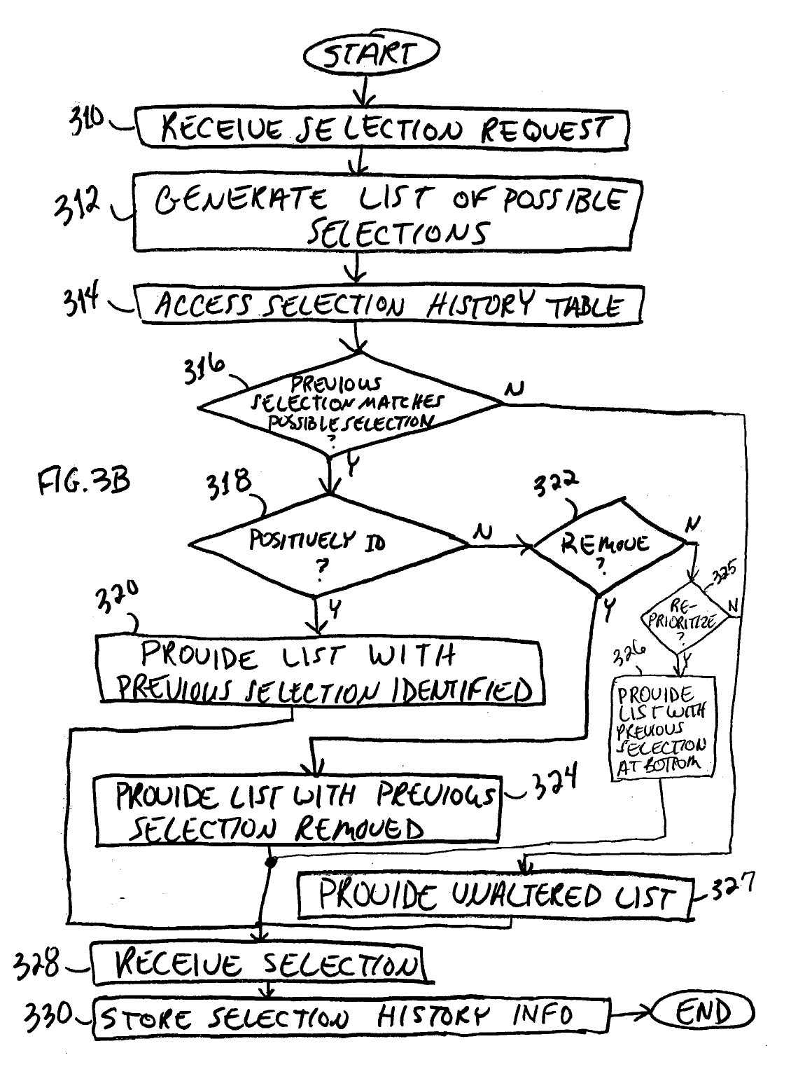

FIGS. 3A-B are flow diagrams illustrating a method for providing previous selection information to a user in the communication system 100 in accordance with one embodiment of the present invention. FIG. 3A illustrates the method from the perspective of a user of the user device 102, and FIG. 3B illustrates the method from the perspective of the remote provider 106.

The method of FIG. 3A begins at step 300 where a user accesses the remote provider 106 through the network 108 using a user device 102. At step 302, the user provides a selection request to the remote provider 106. The selection request comprises a request for a list of possible selections from which to choose and/or a request for a specific selection. For example, the selection request may comprise one or more keywords for a search engine. The list of possible selections may comprise a list of content available for downloading by the user device 102 and/or a list of goods and/or services available for purchase by the user through the user device 102.

At step 304, the user receives a list of possible selections from the remote provider 106. The list of possible selections may comprise selections that are positively identified as previous selections made by the user. Alternatively, the list of possible selections may comprise no selections that correspond to previous selections by the user, either because no such previous selections exist or because such previous selections have been removed from the list by the remote provider 106.

At step 306, the user makes a selection from the list of possible selections, after which the method comes to an end. It will be understood that the selection made by the user may comprise no selection at all.

The method of FIG. 3B begins at step 310 where the remote provider 106 receives a selection request from a user of a user device 102 through the network 108. According to one embodiment, the remote provider 106 may verify the identity of the user by requesting and validating a user name and/or password for the user before or after receiving the selection request.

At step 312, in response to the selection request, the remote provider 106 generates a list of possible selections for the user. As used herein, “in response to” means based on and subsequent to, with or without intervening time and/or actions. At step 314, the previous selection indicator 120 accesses the selection history table 114 to identify previous selections by the user.

At decisional step 316, a determination is made regarding whether or not any of the previous selections in the selection history table 114 match any of the selections in the list of possible selections. If at least one of the previous selections in the selection history table 114 matches one the selections in the list of possible selections, the method follows the Yes branch from decisional step 316 to decisional step 318.

At decisional step 318, a determination is made regarding whether or not the previous selections are to be positively identified in the list of possible selections. If the previous selections are to be positively identified, the method follows the Yes branch from decisional step 318 to step 320. At step 320, the remote provider 106 provides the list of possible selections to the user with the previous selections positively identified.

Returning to decisional step 318, if the previous selections are not to be positively identified, the method follows the No branch from decisional step 318 to decisional step 322. At decisional step 322, a determination is made regarding whether or not the previous selections are to be removed from the list of possible selections. If the previous selections are to be removed, the method follows the Yes branch from decisional step 322 to step 324. At step 324, the remote provider 106 provides the list of possible selections to the user with the previous selections removed from the list.

Returning to decisional step 322, if the previous selections are not to be removed, the method follows the No branch from decisional step 322 to decisional step 325. At decisional step 325, a determination is made regarding whether or not the list of possible selections is to be re-prioritized. If the list of possible selections is to be re-prioritized, the method follows the Yes branch from decisional step 325 to step 326. At step 326, the remote provider 106 provides the list of possible selections to the user with the previous selections re-prioritized to the bottom of the list.

Returning to decisional step 325, if the list of possible selections is not to be re-prioritized, the method follows the No branch from decisional step 325 to step 327. Returning to decisional step 316, if none of the previous selections in the selection history table 114 matches any of the selections in the list of possible selections, the method follows the No branch from decisional step 316 to step 327. At step 327, the remote provider 106 provides the unaltered list of possible selections to the user. From steps 320, 324, 326 and 327, the method continues to step 328.

At step 328, the remote provider 106 receives a selection from the user. At step 330, the remote provider 106 or the previous selection indicator 120 stores the selection history information regarding the selection received from the user in step 328 in the selection history table 114 for future use, after which the method comes to an end. In this way, the remote provider 106 may inform the user of any previously made selections by the user when the user requests a list of selections from the remote provider 106. As a result, the user may avoid making an unintended duplicate selection from the list of possible selections.

Although the present invention has been described with several embodiments, various changes and modifications may be suggested to one skilled in the art. It is intended that the present invention encompass such changes and modifications as fall within the scope of the appended claims.

What is claimed is:

1. A method for providing previous selection information to a user, comprising:
generating a list of possible selections based on a selection request received from the user;
accessing a selection history table to identify previous selections by the user;
determining whether a selection in the list of possible selections matches a previous selection; and
informing the user when a determination is made that a selection in the list of possible selections matches a previous selection.

2. The method of claim 1, informing the user when a determination is made that a selection in the list of possible selections matches a previous selection comprising positively identifying the previous selection.

3. The method of claim 1, informing the user when a determination is made that a selection in the list of possible selections matches a previous selection comprising removing the previous selection from the list of possible selections.

4. The method of claim 1, informing the user when a determination is made that a selection in the list of possible selections matches a previous selection comprising re-prioritizing the list of possible selections.

5. The method of claim 1, further comprising:
receiving a user selection based on the list of possible selections; and
storing selection information based on the user selection in the selection history table.

6. The method of claim 1, the selection history table comprising a combined selection history table operable to identify previous selections by multiple users.

7. A system for providing previous selection information to a user, comprising:
a selection history table operable to store information relating to previous selections by the user; and
a previous selection indicator operable to access the selection history table, to identify a previous selection by the user and to inform the user of the previous selection.

8. The system of claim 7, the selection history table comprising a plurality of previous selection identifiers.

9. The system of claim 8, the selection history table further comprising a plurality of user identifiers, each previous selection identifier having a corresponding user identifier.

10. The system of claim 7, the selection history table provided in one of a remote provider and a user device.

11. The system of claim 7, the selection history table comprising a combined selection history table operable to store information relating to previous selections by multiple users.

12. The system of claim 7, the previous selection indicator operable to inform the user of the previous selection by positively identifying the previous selection.

13. The system of claim 7, the previous selection indicator operable to inform the user of the previous selection by removing the previous selection from a list of possible selections.

14. The system of claim 7, the previous selection indicator operable to inform the user of the previous selection by re-prioritizing the list of possible selections.

15. A system for providing previous selection information to a user, comprising:
a computer-processable medium; and
logic stored on the computer-processable medium, the logic operable to generate a list of possible selections based on a selection request received from the user, to access a selection history table to identify previous selections by the user, to determine whether a selection in the list of possible selections matches a previous selection, and to inform the user when a determination is made that a selection in the list of possible selections matches a previous selection.

16. The system of claim 15, the logic operable to inform the user when a determination is made that a selection in the list of possible selections matches a previous selection by positively identifying the previous selection.

17. The system of claim 15, the logic operable to inform the user when a determination is made that a selection in the list of possible selections matches a previous selection by removing the previous selection from the list of possible selections.

18. The system of claim 15, the logic operable to inform the user when a determination is made that a selection in the list of possible selections matches a previous selection by re-prioritizing the list of possible selections.

19. The system of claim 15, the logic further operable to receive a user selection based on the list of possible selections and to store selection information based on the user selection in the selection history table.

20. The system of claim 15, the selection history table comprising a combined selection history table operable to identify previous selections by multiple users.
